(19) United States
(12) Patent Application Publication
(10) Pub. No.: US 2024/0295399 A1
(43) Pub. Date: Sep. 5, 2024

(54) Physical Location Marking Device

(71) Applicant: Carlos Hernandez, Pleasanton, CA (US)

(72) Inventor: Carlos Hernandez, Pleasanton, CA (US)

(21) Appl. No.: 18/235,043

(22) Filed: Aug. 17, 2023

Related U.S. Application Data
(60) Provisional application No. 63/449,950, filed on Mar. 3, 2023.

(51) Int. Cl. G01C 15/06

(52) U.S. Cl. CPC G01C 15/06

(57) ABSTRACT

A physical location marking device has a primary survey pole, an upper portion atop of which is survey equipment, and a lower portion to which is attached a pole support tip. A marking application holder may be exteriorly attached to the primary survey pole via a rotationally adjustable alignment adapter and a vertically adjustable adapter that together provide up to six degrees of freedom to the marking application holder so a marking applicator (SP) within the marking application holder applies a point marking product to a specific physical location for ground surveying, construction, and other physical location marking needs. The marking application holder may be interior to the primary survey pole. The pole support tip may be conically expanding towards ground with a marking template holder within the pole support tip holding a marking template which has a cut-pattern to apply symbol markings.

### CROSS-REFERENCE TO RELATED APPLICATION

This application claims the benefit of priority of U.S. Provisional Patent Application No. 63/449,950 filed Mar. 11, 2023 and titled “Location Marking Apparatus for Surveying, Construction, and Other Location Marking Needs,” the disclosure of which is incorporated by reference.

### STATEMENT REGARDING FEDERALLY SPONSORED RESEARCH OR DEVELOPMENT

Not Applicable

### BACKGROUND OF THE INVENTION

### Field of Invention

The invention relates generally to the fields of survey and construction and marking equipment and more specifically to devices for marking physical locations.

### Description of Related Art

Surveying is arguably one of the oldest of engineering professions. Ancient Egyptians constructed the pyramids of Egypt several thousand years ago, and the placement accuracy of the stones still rank high as an engineering marvel. How the ancient Egyptians achieved these placement accuracies is lost to history, but recorded history does indicate the methods of mathematical and geographical calculations still used today in surveying technology.

Yet, even the 21st century, with the increased location accuracy of the survey equipment provided by global positioning satellites, one problem still exists-after you move the survey pole—where is the measurement spot?

### SUMMARY OF THE INVENTION

A physical location marking device (100) has a primary pole (105), which has an upper portion (105A) which is capable of supporting survey equipment (110), which may be atop the upper portion (105A). Below the upper portion (105A) is a lower portion (105B) to which is attached a pole support tip (105C) for supporting the physical location marking device (100) on ground (G) or other surface, often used for ground (G) surveying, construction, and other physical location marking.

Coupled to the primary pole (105) between the upper portion (105A) and the pole support tip (105C) of the primary pole (105) is a rotationally adjustable alignment adapter (120) which is coupled via a marking application adapter (125) to a marking application holder (130) so that the rotationally adjustable alignment adapter (120) couples the marking application holder (130) to the primary pole (105).

The rotationally adjustable alignment adapter (120) has a first side with a first end coupler (120A) coupled to the primary pole (105), with a first rotationally adjustable mount (120B) providing three degrees of freedom coupled between the first end coupler (120A) and a main alignable body (120C) so that the first end coupler (120A) couples the first rotationally adjustable mount (120B) to the primary pole (105). Coupled to the first rotationally adjustable mount (120B) is a first side of a main alignable body (120C) which is coupled to a second side of the main alignable body (120C), between which is a tightening adapter (120D). Also coupled to the second side of the main alignable body (120C) is a second rotationally adjustable mount (120E) providing three degrees of freedom to which is coupled a second end coupler (120F).

The second end coupler (120F) also couples to a marking application adapter (125), which is coupled to a marking application holder (130) so the marking application holder (130) is coupled to the primary pole (105) with at least six degrees of freedom.

A vertically adjustable adapter (115) may be used to couple the rotationally adjustable alignment adapter (120) to the pole support tip (105C) such that altogether the marking application holder (130) can be vertically moved and rotated through at least a theoretical seven degrees of freedom with respect to the primary pole (105) for directing a point marking product (PP) from a marking applicator (SP) within the marking application holder (130) to a specific physical location (X) for ground (G) surveying, construction, and other physical location marking.

The first rotationally adjustable mount (120B) provides that the marking application holder (130) is capable of 360 degree rotation clockwise and counterwise on a X axis (roll) plus 180 degrees side to side tilt on a Y axis (yaw) plus 180 degrees up and down tilt on a Z axis (pitch). The second rotationally adjustable mount (120E) provides that the marking application holder (130) is capable of a second 360 degree rotation (roll) plus 180 degrees side to side tilt plus 180 degrees up and down tilt (pitch). The vertically adjustable adapter (115) provides that marking application holder (130) is capable of up and down motion on the primary pole (105).

Other embodiments may use a marking application holder (230) that is internal to a physical location marking device (200) and may include marking templates (375) for use of marking symbols to a specific physical location (X).

### BRIEF DESCRIPTION OF THE DRAWINGS

FIG. 1 shows a physical location marking device (100) for application of a point marking product (PP) to a ground or artificial surface (G) at a specific physical location (X).

FIGS. 2A, 2B, 2C, 2D, 2E, and 2F shows various component vertical translations and rotations of a rotationally adjustable alignment adapter (120) on X, Y, and Z axis.

FIG. 3 shows a physical location marking device (100) modified for focused application of a point marking product (PP) to a ground or artificial surface (G) at a specific physical location (X).

FIG. 4A and FIG. 4B shows a physical location marking device (200) for application of a point marking product (PP) to a ground or artificial surface (G) at a specific physical location (X).

FIG. 5 shows a physical location marking device (300) for application of a point marking product (PP) to a ground or artificial surface (G) at a specific physical location (X).

FIG. 6 physical location marking device (400) for application of a point marking product (PP) to a ground or artificial surface (G) at a specific physical location (X).

### DETAILED DESCRIPTION OF THE INVENTION

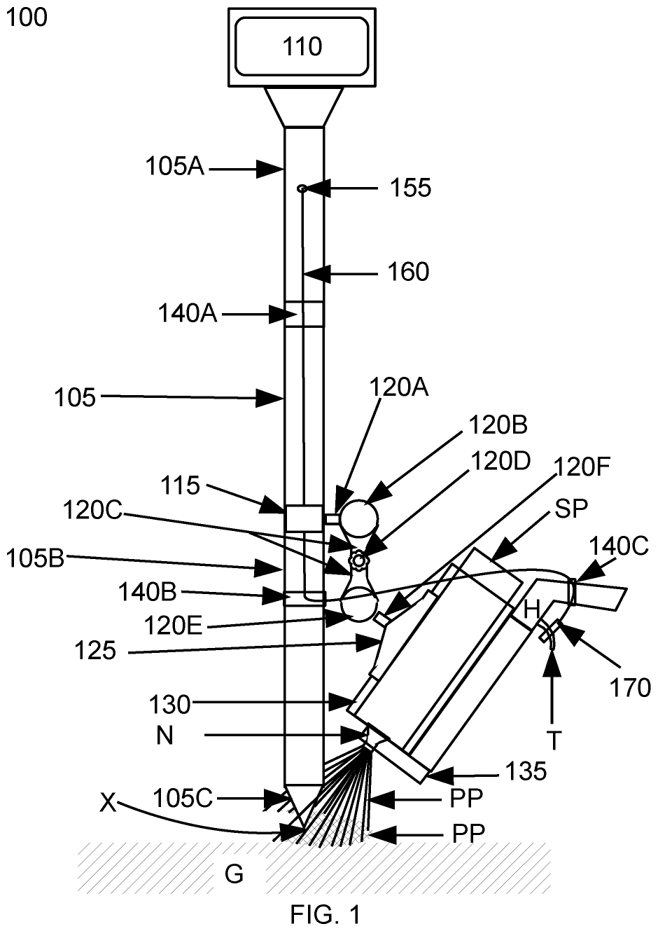

FIG. 1 shows a physical location marking device (100) for application of a point marking product (PP) to a ground or artificial surface (G) at a specific physical location (X) for ground (G) surveying, construction, and other physical location marking.

Shown in FIG. 1 is the physical location marking device (100) having a primary pole (105) with an upper portion (105A), a lower portion (105B), and a pole support tip (105C). Atop the upper portion (105A) may be survey equipment (110). Also shown in FIG. 1 are a vertically adjustable adapter (115) which may be used to vertically adjust the rotationally adjustable alignment adapter (120). The rotationally adjustable alignment adapter (120) has a first end coupler (120A), a first rotationally adjustable mount (120B), a main alignable body (120C) having a first side and a second side, between which is a tightening adapter (120D), a second rotationally adjustable mount (120E), and a second end coupler (120F). The rotationally adjustable alignment adapter (120) is coupled to a marking application adapter (125), which couples a marking application holder (130) to the rotationally adjustable alignment adapter (120). The marking application holder (130) holds a marking applicator (SP), which may be actuated to discharge a point marking product (PP) from a nozzle (N) by a nozzle actuator (135), which may be actuated by a trigger (T) on a handle (H) of the marking application holder (130). The trigger (T) may be actuated by remote actuation cable (160) affixed by an at least one remote actuation support (140A, 140B, 140C) to the primary pole (105) and to the marking application holder (130) as appropriate. The remote actuation cable (160) has a first actuation end (155) that may be affixed to the primary pole (105) and when actuated actuates a second actuation end (170) which here is affixed to and actuates the trigger (T). When actuated, the trigger (T) actuates the nozzle actuator (135) to actuate a nozzle (N) on the marking applicator (SP) so that the marking applicator (SP) directs a point marking product (PP) towards a specific physical location (X) on ground or artificial surface (G) for marking a specific physical location (X).

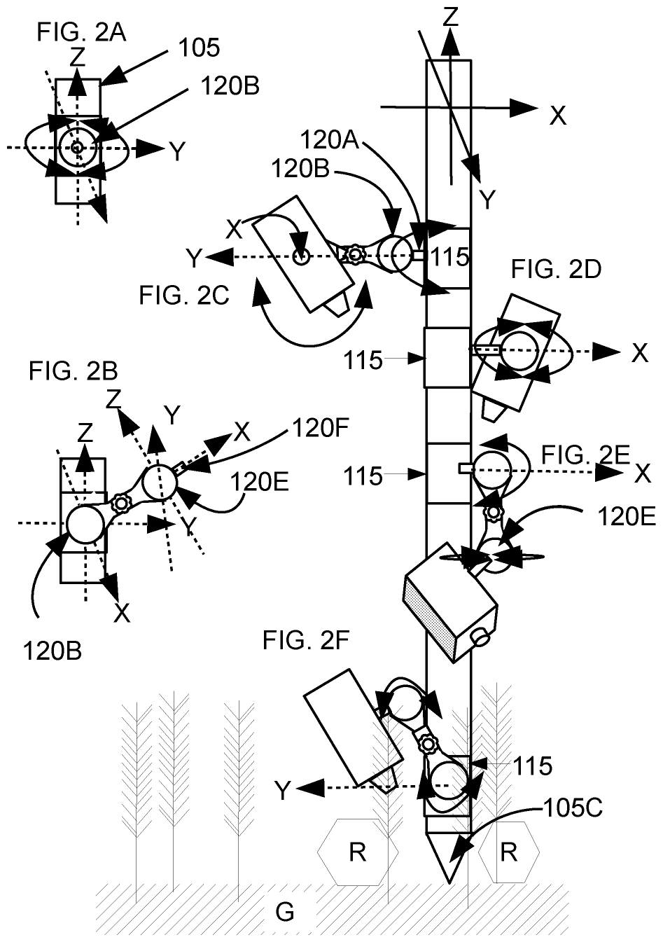

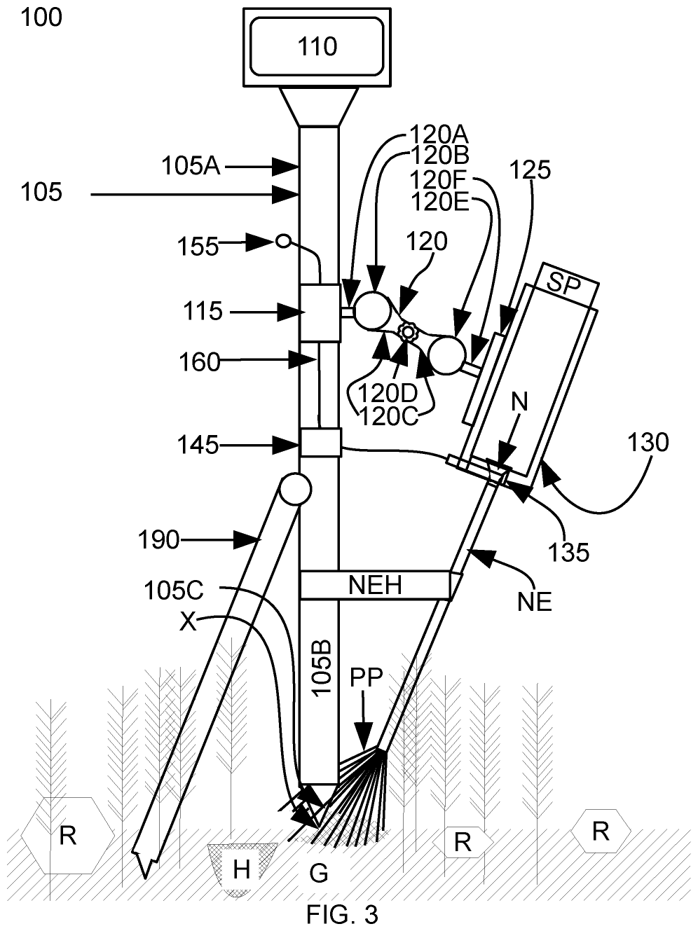

Shown in FIG. 1 are the physical location marking device (100) having a primary pole (105), atop of which may be survey equipment (110). The primary pole (105) has an upper portion (105A), a lower portion (105B) terminating with a pole support tip (105C), which rests on ground or an artificial surface (G) at a specific physical location (X), which may have plants, rocks (R), holes (H), or other irregularities. (See FIGS. 2E and 3).

Coupled to the primary pole (105) between the upper portion (105A) and the pole support tip (105C) is a rotationally adjustable alignment adapter (120). The rotationally adjustable alignment adapter (120) has a first end coupler (120A) having a first end for coupling the rotationally adjustable alignment adapter (120) to the primary pole (105) and a second end for coupling the first end coupler (120A) to a first rotationally adjustable mount (120B) opposite the vertically adjustable adapter (115).

The rotationally adjustable alignment adapter (120) has a main alignable body (120C) having a first side adjustably coupled to the first rotationally adjustable mount (120B) and a second side adjustably coupled to a second rotationally adjustable mount (120E) with a tightening adapter (120D) between the first side of the main alignable body (120C) and the second side of the main alignable body (120C). The first rotationally adjustable mount (120B) provides for three degrees of freedom of the rotationally adjustable alignment adapter (120) with respect to the pole support tip (105C). Coupled to the first rotationally adjustable mount (120B) opposite the first end coupler (120A) is a first side of a main alignable body (120C) of the rotationally adjustable alignment adapter (120) on which is a tightening adapter (120D), which is generally centered onto the main alignable body (120C). The first end coupler (120A) may be movably or immovably affixed to the vertically adjustable adapter (115).

The tightening adapter (120D) bifurcates the main alignable body (120C) of the rotationally adjustable alignment adapter (120) into a first side coupled to the first rotationally adjustable mount (120B) which is coupled to the first end coupler (120A) for coupling to the vertically adjustable adapter (115), and a second side coupled to a second rotationally adjustable mount (120E) which is coupled to a second end coupler (120F) for coupling to a marking application adapter (125) as discussed below. The tightening adapter (120D) tightens and loosens the first side of the main alignable body (120C) to the first rotationally adjustable mount (120B) and tightens and loosens the second side of the main alignable body (120C) to a second rotationally adjustable mount (120E). When tightened, the tightening adapter (120D) sets alignment of the rotationally adjustable alignment adapter (120) with respect to the first end coupler (120A) and the second end coupler (120F).

Similar to the first rotationally adjustable mount (120B), the second rotationally adjustable mount (120E) is coupled to a second end of the second end coupler (120F) and provides three degrees of freedom of the rotationally adjustable alignment adapter (120) with respect to the pole support tip (105C).

Coupled opposite the second rotationally adjustable mount (120E) to a first end of the second end coupler (120F) is a marking application adapter (125), to which is coupled a marking application holder (130). This configuration allows for rotating the first rotationally adjustable mount (120B) and the second rotationally adjustable mount (120E) thus rotationally adjusting the marking application holder (130) with at least six (6) degrees of freedom with respect to the pole support tip (105C).

Also shown attached to the primary pole (105) is a vertically adjustable adapter (115), which is shown attached to the upper portion (105A), but which could be attached to the lower portion (105B), or may be omitted. Attached to the vertically adjustable adapter (115) is the rotationally adjustable alignment adapter (120), which has a first end coupler (120A) that attaches the rotationally adjustable alignment adapter (120) to the vertically adjustable adapter (115). The vertically adjustable adapter (115) functions to vertically adjust the rotationally adjustable alignment adapter (120) with respect to the pole support tip (105C). The vertically adjustable adapter (115) may be integrated into the rotationally adjustable alignment adapter (120).

Also shown are a marking application adapter (125), a marking application holder (130), a nozzle actuator (135), a first actuation end (155) of a remote actuation cable (160) and a second actuation end (170) of the remote actuation cable (160). Also shown is at least one remote actuation support (240A, 240B, 240C) for securing the remote actuation cable (160) to actuate the nozzle actuator (135) when the first actuation end (155) is actuated.

Within the marking application holder (130) is a marking applicator (SP) which can be remotely actuated either via a trigger (T) on the marking application holder (130), or via a remote actuation cable (160) affixed at a first actuation end (155) to the primary pole (105) and to the trigger (T) at a second actuation end (170).

The marking applicator (SP) may have a nozzle (N) or other actuation device. When the marking application holder (130) is aligned via the rotationally adjustable alignment adapter (120) so the nozzle (N) is directed at the specific physical location (X) and the nozzle actuator (135) is actuated, a point marking product (PP) exits from the nozzle (N) towards the specific physical location (X).

By thus vertically aligning the marking application holder (130) using the vertically adjustable adapter (115), and rotationally aligning the marking application holder (130) at least two degrees of freedom using the first rotationally adjustable mount (120B) and rotationally aligning the marking application holder (130) at least two degrees of freedom using the second rotationally adjustable mounting support (150E) of the rotationally adjustable alignment adapter (120), the marking application holder (130) and a marking applicator (SP) within the marking application holder (130) can be moved up and down and rotated through up to six degrees of freedom as to direct a nozzle (N) of the marking applicator (SP) to point towards the pole support tip (105C), and thus discharge a point marking product (PP) from the nozzle (N) to accurately mark a specific physical location (X) on the ground (G) or artificial surface (G) with a point marking product (PP) before moving the primary pole (105).

The primary pole (105) may be made of any material of strength and durability for use as a primary pole. While wood is a historical material, metals such as steel and aluminum, and plastic, including PVC, HDPE, etc., have gained significant use for their durability and longevity, as have composite (e.g. wood-plastic) and other artificially made products, materials, including wood-metal and metal-plastic constructions, and carbon fiber, etc.

The upper portion (105A), lower portion (105B) and pole support tip (105C) portions of the primary pole (105) may be made of the same material or of different materials, with the portions affixed by adjustable mechanical methods (collars, screws, bolts etc.), chemical methods (glue or affixing compounds), or use of both, or other methods. The pole support tip (105C) may be made from one or more natural materials (e.g., wood, metal. etc.), artificial products (polymers, etc.), both, or a combination of both.

As shown in FIG. 1, the pole support tip (105C) is conically narrowing towards ground, i.e., it has a conically narrowing towards-the-ground shape for ‘pin-point’ determination of a specific physical location (X).

The vertically adjustable adapter (115) may be made of any material of strength and durability for use as a vertically adjustable adapter. The first end coupler (120A) may be coupled to the vertically adjustable adapter (115) with mechanical means including a flange with adjustable bands such as worm gear bands, bolts, screws, or adhesives, glues, etc., or thermal means, including metal welding soldering or plastic melding.

The rotationally adjustable alignment adapter (120) may be made of one or more materials. The first end coupler (120A) and the second end coupler (120G) might, for example, be made in the form of rods, bars, or dowels from natural materials (e.g., wood, metal. etc.), artificial products (polymers, etc.), both, or a combination of both.

The first rotationally adjustable mount (120B) and the second rotationally adjustable mount (120E) may be made in the form of spherical bodies or ovoid bodies, etc. from natural materials (e.g., wood, metal. etc.), artificial products (polymers, etc.), both, or a combination of both.

The first side of the main alignable body (120C) and the second side of the main alignable body (120C) may be made from natural materials (e.g., wood, metal. etc.), artificial products (polymers, etc.), both, or a combination of both in the form of a bi-conical body, a cylinder, one or more bars, etc. The first side of the main alignable body (120C) and the second side of the main alignable body (120C) may be made from natural materials (e.g., wood, metal. etc.), artificial products (polymers, etc.), both, or a combination of both.

The tightening adapter (120D) applies tension to the first side of the main alignable body (120C) and to the second side of the main alignable body (120C) as to tighten the first side of the main alignable body (120C) to the first rotationally adjustable mount (120B) and to tighten the second side of the main alignable body (120C) to the second rotationally adjustable mount (120E). The tightening adapter (120D) may be a center located bolt and nut, screw, or one or more bands to tighten the first side of the main alignable body (120C) to the first rotationally adjustable mount (120B) and to tighten the second side of the main alignable body (120C) to the second rotationally adjustable mount (120E).

The marking application adapter (125) functions to couple the second end coupler (120F) of the rotationally adjustable alignment adapter (120) to the marking application holder (130). The marking application adapter (125) may be integrated into the second end coupler (120F), which may be integrated into rotationally adjustable alignment adapter (120). The marking application adapter (125) may be integrated into the marking application holder (130). The marking application adapter (125) may be made from one or more natural materials (e.g., wood, metal. etc.), artificial products (polymers, etc.), both, or a combination of both, or any material suitable to couple the second end coupler (120G) to the marking application holder (130).

The marking application holder (130) functions to hold the marking applicator (SP) for use and is therefore designed (configured) for the particular type of marking applicator (SP). The marking application holder (130) may be an open device, a closed device, or partially open and partially closed. The marking application holder (130) may be made from one or more natural materials (e.g., wood, metal. etc.), artificial products (polymers, etc.), both, or a combination of both, or any suitable material.

The remote actuation cable (160) functions to actuate a trigger (T) on the marking application holder (130). Remote actuation cable (160) is used to refer to a method to actuate a trigger (T) on the marking application holder (130) and not only a mechanical cable. The remote actuation cable (160) can be a direct mechanism, i.e., a cable secured to the primary pole (105) such that the remote actuation cable (160) can actuate the trigger (T), as by a pull or push on the remote actuation cable (160). The remote actuation cable (160) may be part of an electronic actuation system, such as a solenoid system, or a wireless actuation system. The vertically adjustable adapter (115) may be used to the secure the remote actuation cable (160) to the primary pole (105). The remote actuation cable (160) may be within an exterior sheath or connected via ports or through the primary pole (105). Also shown in FIG. 1 is at least one remote actuation support (240A, 240B, 240C) for securing the remote actuation cable (160) for proper functionality to actuate the nozzle actuator (135). The at least one remote actuation support (240A, 240B, 240C) may be secured to the primary pole (105) at the upper portion (105A) or the lower portion (105B) as well as to the marking application holder (130).

The nozzle actuator (135) functions to actuate a nozzle (N) of the marking applicator (SP) to apply the point marking product (PP) to the specific physical location (X). The marking applicator (SP) may have a horizontally actuated nozzle (N) such that a horizontal movement or tilt of the nozzle (N) releases the point marking product (PP). In FIG. 1, the trigger (T) is pivotably attached to a handle (H) of the marking application holder (130) while the second actuation end (170) is secured to the handle (H) to stabilize the remote actuation cable (160) with respect to the handle (H) and the trigger (T). Actuation of the remote actuation cable (160) at the first actuation end (155) moves the remote actuation cable (160) with respect to the trigger (T) which actuates a nozzle actuator (135), which actuates the nozzle (N) on the marking applicator (SP).

The marking applicator (SP) may be pressurized to apply pressure to its contents to eject the point marking product (PP). The marking applicator (SP) may be a can with a nozzle (N) made for marking a specific physical location (X). The point marking product (PP) may be a solute dissolved in a pressurized liquid. The point marking product (PP) may be paint. The point marking product (PP) may be a viscous liquid capable of being squirted from the marking applicator (SP). The point marking product (PP) may be a semi-liquid gel capable of being ejected in a stream from the nozzle, i.e., a ‘squirtable’ gel. The point marking product (PP) may be a semi-liquid plastic capable of being ejected in a stream from the nozzle, i.e., a ‘squirtable’ plastic. The point marking product (PP) may be an aerosol string. The point marking product (PP) may be a synthetic resin. The synthetic resin may be poly-isobutyl methacrylate. The synthetic resin may be a 50-50 copolymer of n-butyl methacrylate and isobutyl methacrylate. The point marking product (PP) may be a polyacrylic resin. The point marking product (PP) may include talc. The point marking product (PP) may include isopropyl alcohol or other microbial inhibitor. The point marking product (PP) may include ammonia or other alkaline compound.

The marking applicator (SP) may apply heat to mark the specific physical location (X). The marking applicator (SP) may be a projectile launcher with a projectile applied to mark the specific physical location (X).

FIGS. 2A, 2B, 2C, 2D, and 2E shows various component vertical translations and rotations of a rotationally adjustable alignment adapter (120) and a marking application holder (130 on X, Y, and Z axis.

FIG. 2A shows a front elevation view of a first rotationally adjustable mount (120B) of a rotationally adjustable alignment adapter (120) attached to primary pole 0(105). A vertically adjustable adapter (115) is present between the rotationally adjustable alignment adapter (120) and the primary pole (105) but is not visible. Also shown is a first three-dimension axis of X (along the first end coupler (120A)), Y (lateral), and Z (vertical). The two round and meeting arrows indicate that the first rotationally adjustable mount (120B) provides for a 360 rotation around the X axis of the rotationally adjustable alignment adapter (120). As shown and explained, the first rotationally adjustable mount (120B) may be configured for one X-Y-Z axis with the second rotationally adjustable mount (120E) configured for different X-Y-Z axis.

FIG. 2B shows the same view of the first rotationally adjustable mount (120B) of a rotationally adjustable alignment adapter (120) attached to primary pole (105) with the addition of a second rotationally adjustable mount (120E) rotated to one side and tilted upward. Also shown is an X-Y-Z axis of the second rotationally adjustable mount (120E), which like the first rotationally adjustable mount (120B), aligns the X axis along its coupler, here the second end coupler (120F). As indicated in FIG. 2B, the X axis of the second rotationally adjustable mount (120E) is rotated towards the Y axis of the first rotationally adjustable mount (120B) and tilted towards the Z axis of the first rotationally adjustable mount (120B). While the shift of the Z axis as shown is about 45 degrees, the Z axis is actually 90 degrees from the X axis. The Y axis is similarly rotated and tilted compared to the Y axis of the first rotationally adjustable mount (120B). These rotations this provide up to six degrees of freedom to the physical location marking device (100).

FIGS. 2C, 2D, 2E and 2F show rotationally adjustable alignment adapter (120) in various configurations attached to a marking application holder (130).

FIG. 2C shows the first rotationally adjustable mount (120B) projecting the main alignable body (120C) along its X axis, while the second rotationally adjustable mount (120E) rotates the marking application holder (130) 90 degrees from the X axis of the first rotationally adjustable mount (120B) and rotates the marking application holder (130) pointed in a negative X and negative Z direction back towards the pole support tip (105C).

FIG. 2D shows a back view of the first rotationally adjustable mount (120B) with the main alignable body (120C) rotated 90 degrees to the X axis of the first rotationally adjustable mount (120B) to align onto a rotated +Y axis. The main alignable body (120C), the second rotationally adjustable mount (120E), and second end coupler (120F) are hidden behind the first rotationally adjustable mount (120B), with the two round and meeting arrows to indicate that the first rotationally adjustable mount (120B) and the second rotationally adjustable mount (120E) are both capable of providing a 360 rotation around the rotated +Y axis. This configuration extends the marking application holder (130) away in the Y direction from primary pole (105) to still point the marking application holder (130) towards the pole support tip (105C).

FIG. 2E shows the main alignable body (120C) rotated on the first rotationally adjustable mount (120B) so the main alignable body (120C) is rotated 90 degrees downward (−Z axis) from the X axis to provide 360 degree rotation on the −Y axis. The second rotationally adjustable mount (120B) has rotated the marking application holder (130) partially along the Y axis to point the marking application holder (130) away from the pole support tip (105C).

FIG. 2F shows the rotationally adjustable alignment adapter (120) with the X axis is pointed directly towards the viewer, with the Y axis to one side. The main alignable body (120C) is rotated on the first rotationally adjustable mount (120B) so the main alignable body (120C) is rotated partially upwards (+Z) and partially outwards (+Y) away from the primary pole (105). The marking application holder (130) is rotated on the second rotationally adjustable mount (120B) so the marking application holder (130) points partially downwards (−Z) and partially towards the primary pole (105) (−Y) to point towards the pole support tip (105C).

As shown, the first rotationally adjustable mount (120B) provides that the main alignable body (120C) is capable of 360 degree rotation clockwise and counterwise on a X axis (roll) plus 180 degrees rotation on a Y axis plus 180 degrees rotation on a Z axis (pitch). By thus rotating the main alignable body (120C), the marking application holder (130) can be rotated using the second rotationally adjustable mount (120E) 360 degree on the Y and Z axis, plus 180 degrees rotation on the X, Z and X, Y axis respectively. The vertically adjustable adapter (115) with the rotationally adjustable alignment adapter (120)thus provide the marking application holder (130) with up to seven degrees of freedom.

FIG. 3 shows a physical location marking device (100) of FIG. 1 modified for focused application of a point marking product (PP) to a ground or artificial surface (G) at a specific physical location (X). An at least one secondary support pole (190) may provide standing support to the primary pole (105).

As shown in FIG. 3, the marking application holder (130) may incorporate the second actuation end (170) of the remote actuation cable (160) into the nozzle actuator (135) thereby incorporating the trigger function.

As shown in FIG. 3, the physical location marking device (100) may incorporate a nozzle extension (NE) which functions, when used, to focus the point marking product (PP) from the from the nozzle (N) of the marking applicator (SP) to the specific physical location (X) for ground (G) surveying, construction, and other physical location marking. The nozzle extension (NE), if present, may be a tube of any suitable material. Plastic tubes of PVC, polyethylene or other plastic may be used but if the paint adheres to the plastic then the plastic tubes would need to be handled as paint contaminated materials. Tubes of silicon could be cleaned albeit with other paint contamination concerns. The physical location marking device (100) may also incorporate a nozzle extension holder (NEH) to affix the nozzle extension (NE) to the primary pole (105).

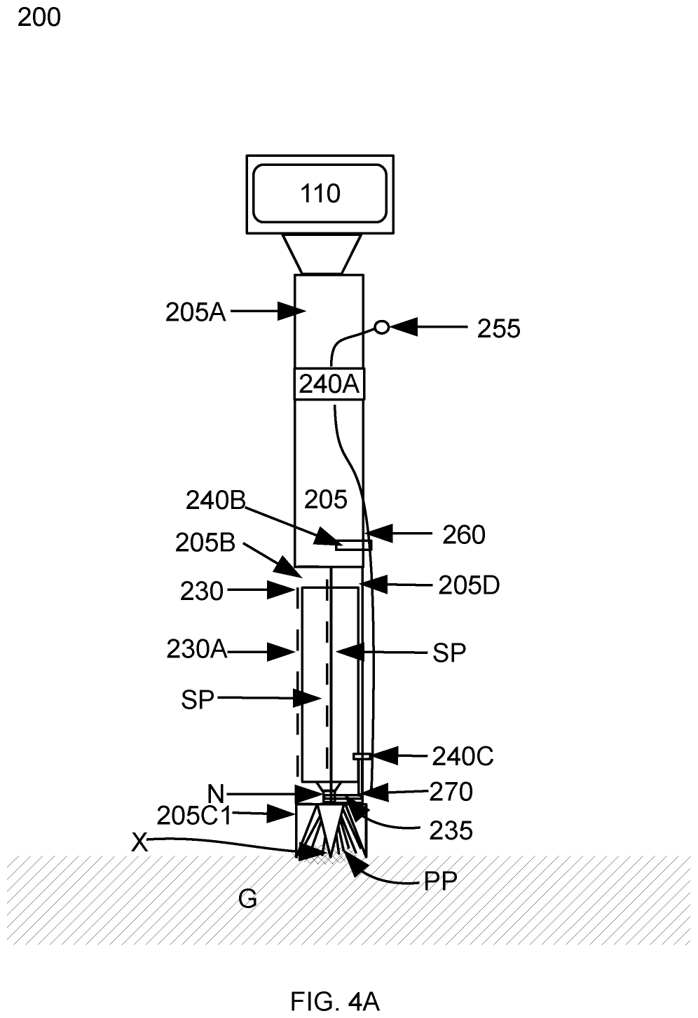

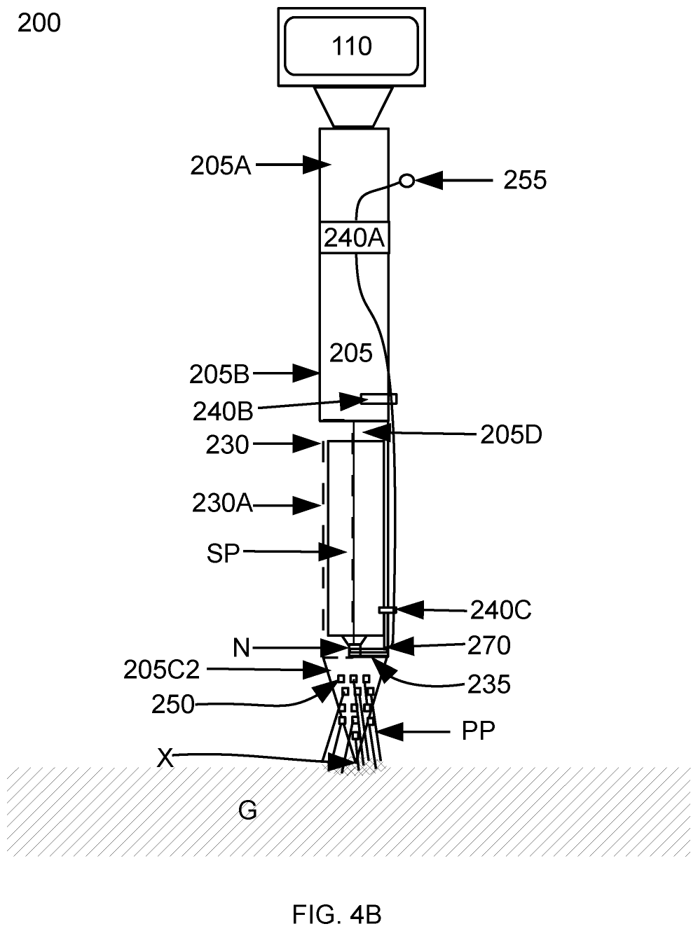

FIG. 4A and FIG. 4B show a physical location marking device (200) for application of a point marking product (PP) to a ground or artificial surface (G) at a specific physical location (X).

Shown in FIG. 4A and FIG. 4B are the physical location marking device (200) having a primary pole (205) with an upper portion (205A), a hollow lower portion (205B), a pole support tip ((205C1), FIG. 4A; (205C2), FIG. 4B) and at least one support strut (205D) between the upper portion (205A) and the pole support tip ((205C1), FIG. 4A; (205C2), FIG. 4B) which rests on ground (G) or an artificial surface (a.k.a. G) at a specific physical location (X) supporting the hollow lower portion (205B). The at least one support strut (205D) may be a side wall of the primary pole (205). Atop the upper portion (205A) may be equipment (110). The physical location marking device (200) incorporates a marking application holder (230) into to a hollow lower portion (205B), thereby eliminating a rotationally adjustable alignment adapter (120) and a vertically adjustable adapter (115) for a non-adjustable marking application holder. Within the primary pole (205) is a side-wall access port (230A) to receive and hold a marking applicator (SP), which may be actuated by a nozzle actuator (235), which is actuated by a remote actuation cable (260) affixed by an at least one remote actuation support (240A, 240B, 240C) to the primary pole (205). The side-wall access port (230A) is for pre-use insertion and post-use removal of a marking applicator (SP). The remote actuation cable (260) has a first actuation end (255) that when actuated actuates a second actuation end (270) which is affixed to and actuates a nozzle actuator (235) to actuate a nozzle (N) on the marking applicator (SP) so that the marking applicator (SP) directs a point marking product (PP) towards a specific physical location (X) on ground or artificial surface (G) for marking of the specific physical location (X).

While the FIG. 1 physical location marking device (100) has a marking applicator (SP) within an marking application holder (130) external to the primary pole (205), the physical location marking device (200) differs by having a primary pole (205) that also functions by having a marking application holder (230) within primary pole (205) with the lower portion (305B) which has a hollow lower portion (205B) configured as a marking application holder (330) that terminates at an upper edge of the pole support tip ((205C1), FIG. 4A, (205C2), FIG. 4B).

The marking application holder (230) similarly holds a marking applicator (SP), but the nozzle (N) of the marking applicator (SP) extends from the hollow lower portion (205B) into the pole support tip ((205C1), FIG. 4A, (205C2), FIG. 4B).

The physical location marking device (200) also has a first actuation end (255) of a remote actuation cable (260), with a second actuation end (270) of the remote actuation cable (260) secured to a nozzle actuator (235) to actuate a nozzle (N) of a marking applicator (SP) within marking application holder (230) of the hollow lower portion (205B) of the primary pole (205) to apply the point marking product (PP) to a specific physical location (X) for ground (G) surveying, construction, and other physical location marking.

The physical location marking device (200) may also have at least one remote actuation support (240), shown as 240A, 240B, and 240C, to secure the remote actuation cable (260) to the primary pole (205).

The physical location marking devices (200) of FIG. 4A and FIG. 4B differ in that the pole support tip (205C1) of FIG. 4A has a plurality of conically narrowing towards-the-ground tips so the point marking product (PP) exits towards the specific physical location (X) between the plurality of conically narrowing towards-the-ground tips. In contrast, the pole support tip (205C2) of FIG. 4B has a single conically narrowing towards the ground tip with a plurality of marking discharge nozzles (250) below the nozzle (N) of the marking applicator (SP) for application of a point marking product (PP) to exteriorly exit the pole support tip (205C2) through the plurality of marking discharge nozzles (250) to the specific physical location (X).

The primary pole (205) may be made of the same materials as primary pole (105). The primary pole (205) may be one piece or multiple pieces connected together. The connections may be threaded rods and holes, slip connections, or other affixed connections.

Some embodiments of the physical location marking device (200) may have an upper portion (205A) identical to the upper portion (105A) of the physical location marking device (100). The upper portion (205A) may differ from the upper portion (105A) of the physical location marking device (100).

Some embodiments of the physical location marking device (200) may have a upper portion (205A) that is solid with a hollow lower portion (205B) functioning as a marking application holder (230). The hollow lower portion (205B) may be partially hollow, i.e., a portion is solid above, below, or above and below that marking applicator (SP).

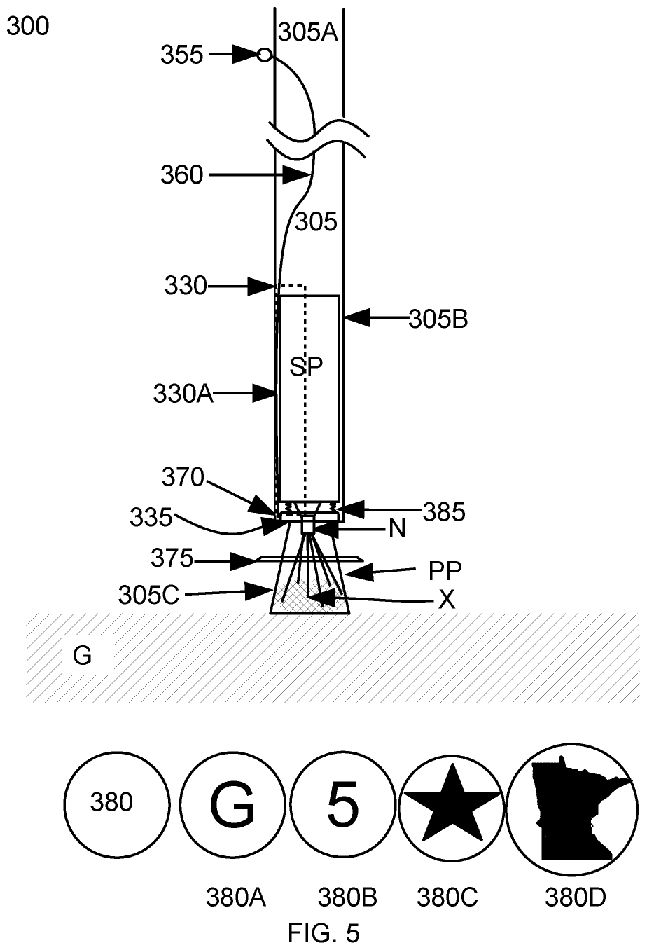

FIG. 5 shows a physical location marking device (300) of a modification of the physical location marking device (200) for application of a point marking product (PP) to a ground or artificial surface (G) at a specific physical location (X).

Shown in FIG. 5 are a primary pole (305), an upper portion (305A) (survey equipment (110) is not shown), a lower portion (305B) of the primary pole (305), a pole support tip (305C), a marking application holder (330), with side-wall access port (330A), a vertical nozzle actuator (335), a marking template holder (375), and a marking template (380).

Within the lower portion (305B) is shown a marking application holder (330) with a side-wall access port (330A) for pre-use insertion and post-use removal of a marking applicator (SP). Within the marking application holder (330) is shown a marking applicator (SP).

Unlike the pole support tips (105C, 205C) of the physical location marking device (100) and the physical location marking device (200), the pole support tip (305C) of the physical location marking device (300) may be cylindrical, i.e., straight, or may be conically expanding towards ground, i.e., having a conically expanding towards-the-ground shape. These shapes facilitate confined application of a point marking product (PP).

The physical location marking device (300) may have a first actuation end (355), a remote actuation cable (360), and second actuation end (370) to actuate a nozzle actuator (335). The nozzle actuator (335) may be configured as a vertically actuated nozzle (N) to surround a lower end of the nozzle (N) of the marking applicator (SP) such a vertical movement of the nozzle (N) releases the point marking product (PP). Pressing down (i.e., down-press) on the primary pole (305) causes the vertical nozzle actuator (335) to actuate the nozzle (N) to direct the point marking product (PP) toward a ground or artificial surface (G) at a specific physical location (X). An at least one standoff (385) may be present to hold the marking applicator (SP) from the vertical nozzle actuator (335) to prevent accidental nozzle actuation. The at least one standoff (385) may be reversibly compressible.

Below the marking applicator (SP) is the pole support tip (305C) of the physical location marking device (300), within which is a marking template holder (375). Marking template holder (375) functions to hold a marking template (380) configured with a cut-pattern to provide a distinguishable marking as a reminder of the purpose of the marking.

Also shown in FIG. 5 are a plurality of marking templates (380A, 380B, 380C, 380D) which illustrate different marking symbol types that may be used for different marking characterizations. Marking template (380A) illustrates an alphabetic symbol which includes non-English language characters and linguistic symbols. Marking template (380B) illustrates a numeric symbol. Marking template (380C) illustrates a standard polygonal symbol. Marking template (380D) illustrates non-standard polygonal symbol. A marking template (380) may have at least one symbol and could use more than one marking symbol type. The cut-pattern of the marking template (380) includes alphabetical symbols which includes non-English language characters and linguistic symbols (380A), numeric symbols (380A), standard polygonal symbols (380A), non-standard polygonal symbols (380A), and any cut-pattern used for marking characterizations.

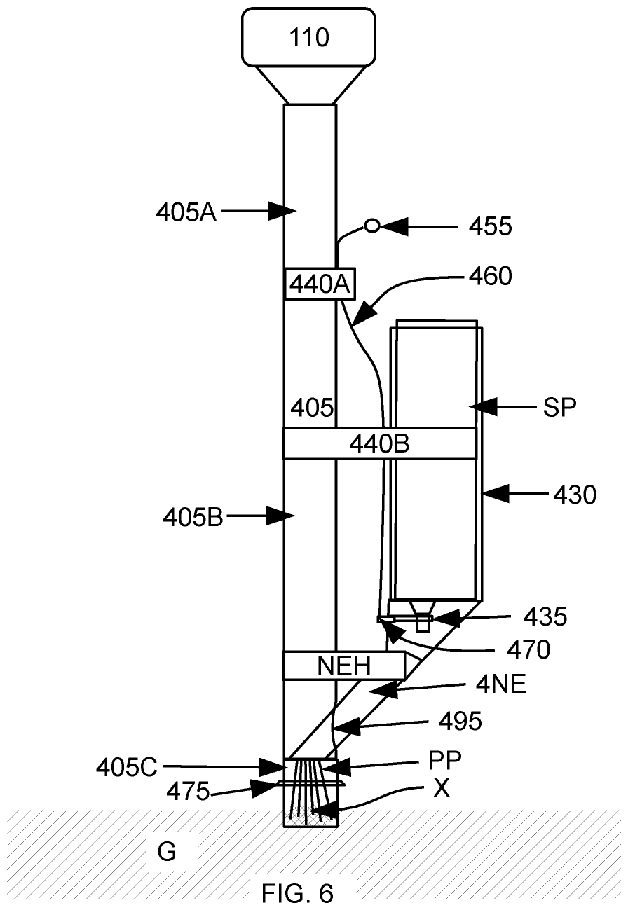

FIG. 6 show a physical location marking device (400) for application of a point marking product (PP) to a ground (G) or an artificial surface (G) at a specific physical location (X).

Shown in FIG. 6 are a physical location marking device (400), a primary pole (405), an upper portion (105A), a lower portion (405B), a pole support tip (405C), a marking application holder (430), a distal end (430D), a nozzle actuator (435), an at least one remote actuation support (440A, 440B), a first actuation end (455), a remote actuation cable (460), a second actuation end (470), a marking template holder (475), a nozzle extension port (495), a marking applicator (SP), a nozzle (N), an angular nozzle extension (4NE), a nozzle extension holder (NEH), a point marking product (PP), and a specific physical location (X).

Affixed to the lower portion (405B) of the primary pole (405) is an at least one remote actuation support (440A) to which is affixed a remote actuation cable (460) having a first actuation end (455) and a second actuation end (470) for actuating a nozzle actuator (435).

Also attached to the at least one remote actuation support (440A) is a marking application holder (430). The marking application holder (430) is configured for holding a marking applicator (SP), which has a nozzle (N) protruding from the marking application holder (430) into an angular nozzle extension (4NE). Actuation of the first actuation end (455) causes the remote actuation cable (460) to actuate the second actuation end (470), which actuates a nozzle actuator (435), which actuates the nozzle (N) of the marking applicator (SP) to release a point marking product (PP).

The angular nozzle extension (4NE) is attached to and angularly extends from a distal end of the marking application holder (430) through a nozzle extension port (495) in the lower portion (405C) of the primary pole (405). A nozzle extension holder (NEH) may affix the angular nozzle extension (4NE) to the lower portion (405C) of the primary pole (405).

The angular nozzle extension (4NE) angularly directs the point marking product (PP) from the nozzle (N) of the marking applicator (SP) into the lower portion (405C) and out of the primary pole (405) via the pole support tip (405C) to apply the point marking product (PP) to a specific physical location (X) for physical location marking.

The components of the physical location marking device (400) may be fabricated in the same manner and materials as the corresponding materials of the physical location marking device (100), physical location marking device (200), and physical location marking device (300).

These descriptions and drawings are embodiments and teachings of the disclosure. All variations are within the spirit and scope of the disclosure. This disclosure is not to be considered as limiting the claims to only the embodiments illustrated or discussed. Certain changes can be made in the subject matter without departing from the spirit and the scope of this invention. It is realized that changes are possible within the scope of this invention and it is further intended that each structure or element recited in any of the claims is to be understood as referring to all equivalent structure or elements. The following claims are intended to cover the invention as broadly as possible in whatever form it may be used.

What is claimed is:

1. A physical location marking device (100) for physical location marking comprising:
a. a primary pole (105) having an upper portion (105A) capable of supporting survey equipment (110) atop the primary pole (105) and a lower portion (105B) terminating with a pole support tip (105C),
b. a rotationally adjustable alignment adapter (120) coupled to the primary pole (105) between the upper portion (105A) and the pole support tip (105C) comprising
c. a first end coupler (120A) having a first end for coupling the rotationally adjustable alignment adapter (120) to the primary pole (105) and a second end for coupling the first end coupler (120A) to a first rotationally adjustable mount (120B),
d. the rotationally adjustable alignment adapter (120) having a main alignable body (120C) having a first side adjustably coupled to the first rotationally adjustable mount (120B) and a second side adjustably coupled to a second rotationally adjustable mount (120E) with a tightening adapter (120D) between the first side of the main alignable body (120C) and the second side of the main alignable body (120C),
e. the tightening adapter (120D) configured to set alignment of the rotationally adjustable alignment adapter (120) by tightening and loosening the first side of the main alignable body (120C) to the first rotationally adjustable mount (120B) and by tightening and loosening the second side of the main alignable body (120C) to a second rotationally adjustable mount (120E),
f. the second rotationally adjustable mount (120E) coupled to a second end of a second end coupler (120F), the second end coupler (120F) having a first end coupled to a marking application adapter (125),
g. the marking application adapter (125) configured for coupling the rotationally adjustable alignment adapter (120) to a marking application holder (130),
h. the first rotationally adjustable mount (120B) provides at least two degrees of freedom so that the marking application holder (130) is capable of 360 degree rotation clockwise and counterwise on a X axis (roll) plus 180 degrees side to side tilt on a Y axis (yaw) and 180 degrees up and down tilt on a Z axis (pitch),
i. the second rotationally adjustable mount (120E) provides at least two degrees of freedom so that the marking application holder (130) is capable of 360 degree rotation clockwise and counterwise on a X axis (roll) plus 180 degrees side to side tilt on a Y axis (yaw) and 180 degrees up and down tilt on a Z axis (pitch), and
j. the marking application holder (130) configured for holding a marking applicator (SP) having a nozzle (N), the marking application holder (130) having a nozzle actuator (135) configured to couple with the nozzle (N), such that when the marking application holder (130) is aligned via the rotationally adjustable alignment adapter (120) so the nozzle (N) is directed at a specific physical location (X) and the nozzle actuator (135) actuated to actuate the nozzle (N) the nozzle (N) directs a point marking product (PP) from a nozzle (N) of the marking applicator (SP) to a specific physical location (X) for physical location marking.

2. The physical location marking device (100) of claim 1 wherein the pole support tip (105C) is conically narrowing towards ground.

3. The physical location marking device (100) of claim 1 further comprising a remote actuation cable (160) having a first actuation end (155) affixed on the primary pole (100) and a second actuation end (170) to actuate a trigger (T) for remotely actuating the nozzle actuator (135) for remotely actuating the nozzle (N) of the marking applicator (SP) to apply the point marking product (PP) to a specific physical location (X) for physical location marking.

4. The physical location marking device (100) of claim 1 further comprising a vertically adjustable adapter (115) for vertically adjusting the rotationally adjustable alignment adapter (120) on the primary pole with respect to the pole support tip (105C) to provide additional vertical adjustment to the marking application holder (130).

5. The physical location marking device (100) of claim 1 further comprising a nozzle extension (NE) to focus the point marking product (PP) from the nozzle (N) of the marking applicator (SP) to a specific physical location (X) for physical location marking.

6. The physical location marking device (100) of claim 1 further comprising at least one remote actuation support (240A, 240B, 240C) for securing the remote actuation cable (160) to actuate the nozzle actuator (135) when the first actuation end (155) is actuated.

7. (canceled)

8. (canceled)

9. A physical location marking device (200) for physical location marking comprising:
a. a primary pole (205) having an upper portion (205A) capable of supporting survey equipment (110) atop the primary pole (205) and a hollow lower portion (205B) terminating with a pole support tip (205C1),
b. the hollow lower portion (205B) comprising a marking application holder (230) for receiving a marking applicator (SP) with a side-wall access port (230A) configured for pre-use insertion and post-use removal of the marking applicator (SP) with at least one support strut (205D) between the upper portion (205A) and the pole support tip (205C1) supporting the hollow lower portion (205B).

10. The physical location marking device (200) of claim 9 wherein the pole support tip (205C1) comprises a plurality of conically narrowing towards-the-ground tips so the point marking product (PP) exits the nozzle (N) towards a specific physical location (X) between the plurality of tips.

11. The physical location marking device (200) of claim 9 wherein pole support tip (205C2) comprises a single conically narrowing towards the ground tip and comprises a plurality of marking discharge nozzles (250) for discharging a point marking product (PP) from the marking applicator (SP) so the point marking product (PP) exteriorly exits the pole support tip (205C2) through the plurality of marking discharge nozzles (250) to apply the point marking product (PP) to a specific physical location (X) for physical location marking.

12. The physical location marking device (200) of claim 9 for physical location marking further comprising a remote actuation cable (260) having a first actuation end (255) affixed to the primary pole (205) and a second actuation end (270) affixed to a nozzle actuator (235) for remotely actuating the nozzle actuator (235) to actuate a nozzle (N) of the marking applicator (SP) to apply the point marking product (PP) to a specific physical location (X) for physical location marking.

13. A physical location marking device (300) for physical location marking comprising a primary pole (305) having an upper portion (305A) capable of supporting survey equipment (110) atop the primary pole (305) and a lower portion (305B) with a pole support tip (305C),
a. the lower portion (305B) comprising a hollow portion configured as a marking application holder (330) for holding a marking applicator (SP) with a nozzle (N) of the marking applicator (SP) extending from the lower portion (305B) into the pole support tip (305C) with a side-wall access port (330A) for pre-use insertion and post-use removal of the marking applicator (SP),
b. a vertical nozzle actuator (335) configured to surround a lower end of the nozzle (N) of the marking applicator (SP), and
c. the vertical nozzle actuator (335) configured wherein a downpress of the primary pole (305) actuates the nozzle (N) of the marking applicator (SP) to discharge a point marking product (PP) to a ground or artificial surface (G) at a specific physical location (X).

14. The physical location marking device (300) of claim 13 further comprising at least one reversibly compressible standoff (385) to hold the marking applicator (SP) from the vertical nozzle actuator (335) to prevent accidental nozzle actuation.

15. The physical location marking device (300) of claim 13 wherein the pole support tip (305C) is conically expanding towards ground.

16. The physical location marking device (300) of claim 13 wherein the pole support tip (305C) is cylindrical.

17. The physical location marking device (300) of claim 13 for physical location marking further comprising a marking template holder (375) within the pole support tip (305C) configured for holding a marking template (380) [0073]configured with a cut-pattern to allow the point marking product (PP) to pass through the marking template (380) as to apply the point marking product (PP) in the cut-pattern of the marking template (380) to a specific physical location (X) to provide a distinguishable marking as a reminder of the purpose of the physical location marking.

18. The physical location marking device (300) of claim 17 wherein the cut-pattern of the marking template (380) comprises a cut-pattern selected from the group consisting of alphabetical symbols (380A), numeric symbols (380A), standard polygonal symbols (380A), and non-standard polygonal symbols (380A).

19. A physical location marking device (400) comprising a primary pole (405) comprising an upper portion (105A), a lower portion (405B), and a pole support tip (405C),
a. a marking application holder (430) affixed to the primary pole (405), the marking application holder (430) configured for holding a marking applicator (SP) and comprising a nozzle actuator (435) configured to actuate a nozzle (N) of the marking applicator (SP),
b. the marking application holder (430) comprising a distal end (430D) to which is attached an angular nozzle extension (4NE), the angular nozzle extension (4NE) configured to angularly direct a point marking product (PP) from the marking applicator (SP) when the nozzle (N) is actuated so the point marking product (PP) passes through a nozzle extension port (495) into the lower portion (405C) of the primary pole (405) and out of the primary pole (405) via the pole support tip (405C) to apply the point marking product (PP) to a specific physical location (X) for physical location marking.

20. (canceled)

21. The physical location marking device (100) of claim 1 wherein the point marking product (PP) comprises paint.

22. The physical location marking device (100) of claim 1 wherein the point marking product (PP) comprises squirtable plastic.

23. The physical location marking device (400) of claim 19 wherein the pole support tip (305C) is configured for holding a marking template (380) configured with a cut-pattern to allow the point marking product (PP) to pass through the marking template (380) as to apply the point marking product (PP) in the cut-pattern of the marking template (380) to a specific physical location (X) to provide a distinguishable marking as a reminder of the purpose of the physical location marking need.
